(19) United States
(12) Patent Application Publication
(10) Pub. No.: US 2004/0158830 A1
(43) Pub. Date: Aug. 12, 2004

(54) Apparatus and method for executing applet

(75) Inventors: Hyun-kwon Chung, Seoul (KR); Jung-kwon Heo, Seoul (KR); Sung-wook Park, Seoul (KR); Kil-soo Jung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/728,097

(22) Filed: Dec. 5, 2003

(30) Foreign Application Priority Data
Dec. 6, 2002 (KR) 2002-77280

(51) Int. Cl. G06F 9/455

(52) U.S. Cl. 718/1

(57) ABSTRACT

An apparatus and a method of executing an applet in an apparatus reproducing interactive contents. The method involves receiving a request for executing an applet from a browser, determining whether the applet is a bound applet or an unbound applet, and loading the applet into a virtual machine. If the loaded applet is an unbound applet, predetermined commands to the virtual machine are issued, so that the applet can fall into an ‘initiate’ state and into a ‘start’ state, respectively.

### CROSS-REFERENCE TO RELATED APPLICATIONS

This application claims the priority of Korean Patent Application No. 2002-77280, filed on Dec. 6, 2002, in the Korean Intellectual Property Office, the disclosure of which is incorporated herein in its entirety by reference.

### BACKGROUND OF THE INVENTION

1. Field of the Invention

The present invention relates to an apparatus and a method of executing an applet, and more particularly, to an apparatus and a method of executing an applet connected to markup documents for supporting interactive functions in an apparatus reproducing interactive contents.

2. Description of the Related Art

Interactive contents refers to audio/video (A/V) data recorded on a data storage medium, for example, an interactive video, along with markup documents supporting interactive functions. Markup documents are documents written in a markup type language, such as hypertext markup language (HTML) or extended markup language (XML).

AV data recorded on an interactive DVD can be reproduced in the same manner as ordinary A/V data recorded on a DVD-video or can be displayed along with the markup documents in a manner that embeds, via a browser, an AV screen on which the AV data is displayed into a display window specified by the markup documents. Of these two different display modes, the latter is called an interactive mode for supporting interactive functions. For example, in a case where the AV data recorded on an interactive DVD is a movie title, a movie can be displayed in one part of a display window, and a variety of interactive contents, such as subtitles and still pictures for advertising previews, can be displayed in other parts of the display window, and, accordingly this type of AV data displaying technique is referred to as an interactive function.

In general, an applet is connected to markup documents so that a variety of interactive functions can be served. An applet corresponds to a small application program, typically created using an object-oriented programming language, such as Java, so that the applet can be transmitted to users along with web pages, i.e., markup documents. A Java applet can perform simple processes, such as animation or simple calculations, without the need for issuing any request to a server.

Conventionally, all applets are dependent on markup documents connected thereto. Thus, if a markup document is unloaded and another document is loaded, an applet connected to the unloaded markup document has to stop operating. If the markup document is called by a user and displayed on a screen, the applet connected to the markup document resumes work/executing.

### SUMMARY OF THE INVENTION

The present invention provides an apparatus and a method of executing two different applets, one applet that is dependent on a markup document and another applet that is independent of (i.e., not dependent on) a markup document.

Additional aspects and/or advantages of the invention will be set forth in part in the description which follows and, in part, will be obvious from the description, or may be learned by practice of the invention.

According to an aspect of the present invention, there is provided an apparatus executing an applet. The apparatus includes a memory, a virtual machine, a browser, and an application manager. The memory stores a markup document input thereinto. The virtual machine executes an applet. The browser receives the markup document from the memory and outputs information about an applet included in the markup document. The application manager receives the applet information from the browser, retrieves the applet from a source, which is typically an external source, controls the applet to be stored in the memory, receives a request for executing the applet, loads the requested applet as stored in the memory into the virtual machine, determines whether the loaded requested applet is a bound applet or an unbound applet, issues a predetermined command to the virtual machine so that the loaded requested applet can fall into an ‘initiate’ state, if the requested loaded applet is an unbound applet; and issues a command to the virtual machine so that the loaded requested unbound applet can fall into a ‘start’ state.

According to another aspect of the present invention, there is provided a method of executing an applet by receiving a request for executing an applet; determining whether the requested applet is a bound applet or an unbound applet; loading the requested applet as stored in a memory into a virtual machine; if the loaded requested applet is an unbound applet, issuing a predetermined command to the virtual machine so that the loaded requested unbound applet can fall into an ‘initiate’ state; and issuing a predetermined command to the virtual machine so that the loaded requested unbound applet can fall into a ‘start’ state.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a schematic view of a system reproducing interactive contents;

FIG. 2 is a diagram of an AV screen displayed along with a markup document screen via a browser as the interactive contents;

FIG. 3 is a directory structure of data stored on an interactive contents storage medium;

FIG. 4 is a diagram illustrating components of a markup document displayed on a screen via a browser;

FIG. 5 is a detailed functional block diagram of an apparatus reproducing interactive contents in the system of FIG. 1, according to an embodiment of the present invention;

FIG. 6 is a detailed functional block diagram of a presentation engine of FIG. 5, according to an embodiment of the present invention;

FIG. 7 is a detailed functional block diagram of a Java virtual machine (JVM) of FIG. 6, according to an embodiment of the present invention;

FIG. 8 is a detailed functional block diagram of a browser of FIG. 6, according to an embodiment of the present invention;

FIG. 9 is a diagram of interactions among a JVM, a browser, and an application manager, according to an embodiment of the present invention;

FIG. 10 is a life cycle state diagram of a bound applet, according to an embodiment of the present invention;

FIG. 11 is a life cycle state diagram of an unbound applet, according to an embodiment of the present invention;

FIG. 12 is a flowchart of executing an applet, according to an embodiment of the present invention; and

FIGS. 13A through 13E are example images of interactive contents with a bound applet and an unbound applet of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

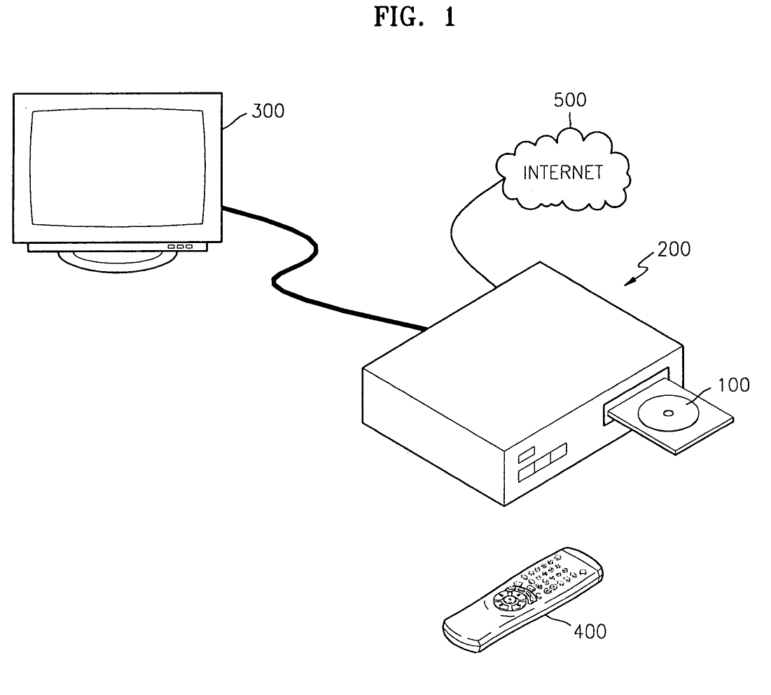

FIG. 1 is a schematic view of a system reproducing interactive contents. Referring to FIG. 1, the system comprises a contents storage medium 100, an apparatus 200 reproducing interactive contents, a display unit 300, a remote controller 400, and Internet 500.

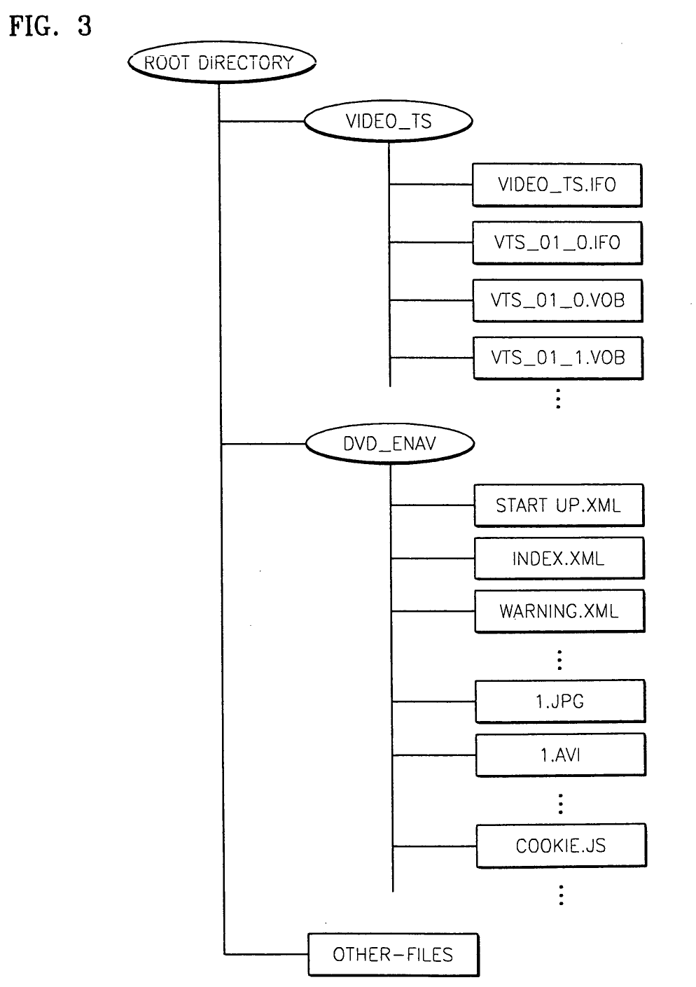

The contents storage medium 100 is a storage medium that can store interactive contents, such as an interactive DVD. Typically, the interactive DVD stores AV data, markup document data, and other data. FIG. 3 is a directory structure of data stored on the contents storage medium 100. Referring to FIG. 3, typically, a root directory comprises a VIDEO_TS directory, a DVD_ENAV directory storing data supporting interactive functions, such as markup document data, and an OTHER-FILES directory.

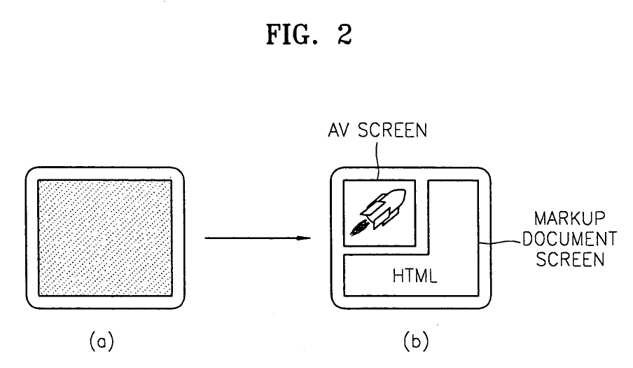

FIG. 2 is a diagram of an AV screen displayed along with a markup document screen, via a browser, as the interactive contents. As shown in FIG. 2, the apparatus 200 may reproduce AV data recorded on the contents storage medium 100 in a regular manner in the AV screen (a). Alternatively, the apparatus 200 may display the AV data along with markup documents by embedding, via a browser, an AV screen, on which the AV data is reproduced and displayed, into a markup document screen defined by the markup documents, as the interactive contents (b) screen shown in FIG. 2. In addition, the apparatus 200 may reproduce interactive contents received from a network, such as the Internet 500. For example, a user can play online games through the Internet 500 by using the apparatus 200.

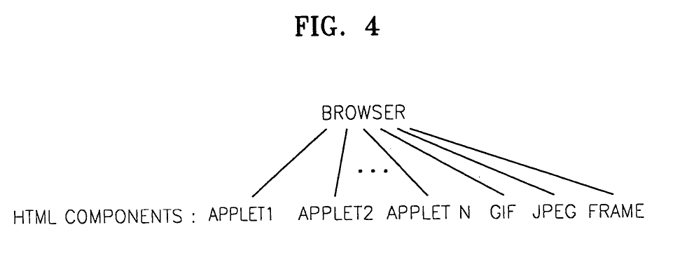

FIG. 4 is a diagram illustrating components of a markup document displayed on a screen via a browser. As shown in FIG. 4, typically, a markup document written in HTML comprises a plurality of HTML components, such as a plurality of applets, still pictures, such as GIF and JPEG, and frames.

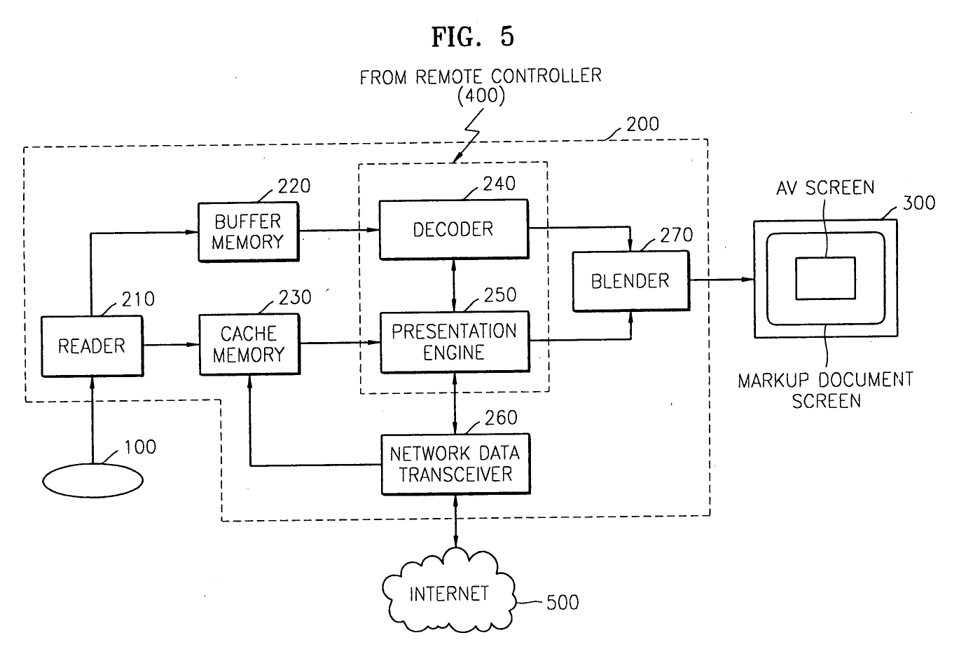

FIG. 5 is a detailed functional block diagram of the apparatus 200 reproducing interactive contents, according to an embodiment of the present invention. Referring to FIG. 5, the apparatus 200 comprises a reader 210, a buffer memory 220, a cache memory 230, a decoder 240, a presentation engine 250, a network data transceiver 260, and a blender 270.

Typically, the reader 210 comprises a pickup unit (not shown), which reads data from the contents storage medium 100 and outputs AV data to the buffer memory 220. In addition, typically, the reader 210 reads and outputs markup document data for interactive functions and for related applets to the cache memory 230. The decoder 240 receives and decodes the AV data stored in the buffer memory 220. For example, the decoder 240 decodes MPEG-encoded video data, or MPEG-encoded or AC3-encoded audio data, and outputs decoded AN data to the blender 270. Typically, the presentation engine 250 receives and interprets the markup document data stored in the cache memory 230 and then outputs a result of the interpretation to the blender 270. In addition, typically, the presentation engine 250 receives a user operation (UOP) from the remote controller 400 and carries out interactive functions in response to the input UOP. Typically, the UOP comprises various commands input by a user using the remote controller 400, such as a command to reproduce data, a command to stop reproducing data, and a command to temporarily stop reproducing data, and navigation keys input necessary for reproducing interactive contents. The network data transceiver 260 communicates with a remote server (not shown) via the Internet 500.

Accordingly, typically, the blender 270 either outputs decoded A/V data, which is input (read) from the buffer memory 220, to the display unit 300 to display an ordinary AN screen (a) as shown in FIG. 2, or mixes the input decoded AN data with the input interpreted markup document data to output an interactive contents screen (b) as shown in FIG. 2, in which the AV screen displaying the input decoded AV data is embedded into a markup document screen defined by the input interpreted markup document data (also shown in FIG. 5).

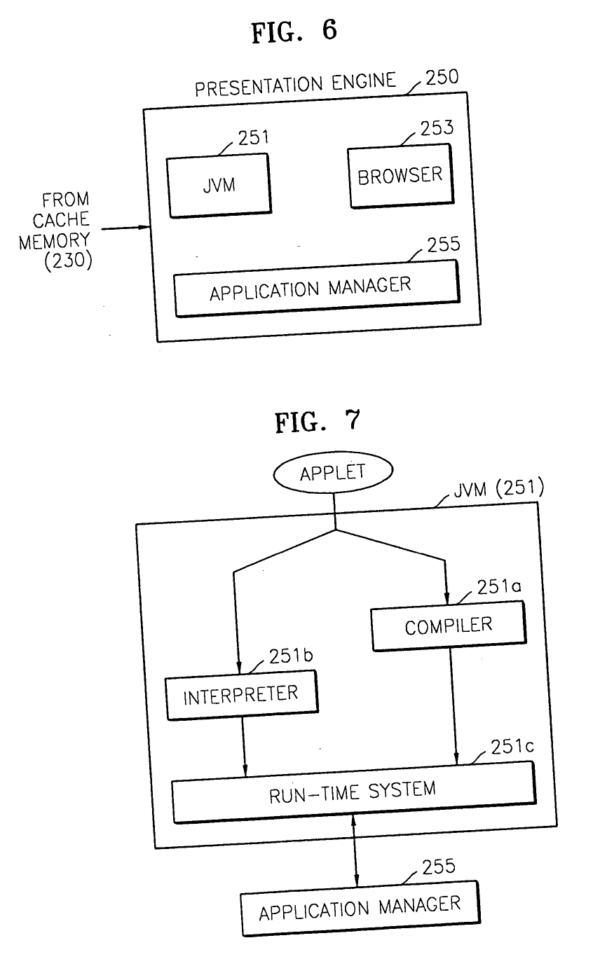

FIG. 6 is a detailed functional block diagram of the presentation engine if FIG. 5 Referring to FIG. 6, typically, the presentation engine 250 comprises a Java virtual machine (JVM) 251, a browser 253, and an application manager 255. As will be described in more detail further below, the JVM 251 executes a Java applet connected to a markup document as a bound applet or an unbound applet, as the case may be. The present invention is not limited to a JVM, but a virtual machine for executing an applet based on a program other than Java could also be provided in the presentation engine 250. Hereinafter, however, only an occasion when a Java applet and the JVM 251 are used will be described as an embodiment of the present invention.

The browser 253 interprets a markup document and displays the markup document using the display device 300 (of FIG. 1). The application manager 255 manages the operation of the JVM 251 and an application, such as the browser 253. The application manager 255 could be an independent management program or part of an operating system (OS) of the apparatus 200.

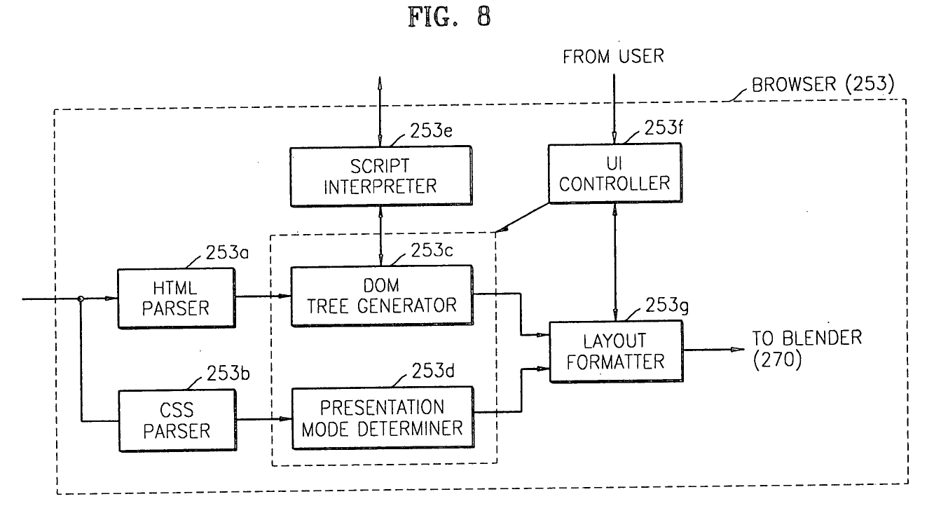

FIG. 7 is a detailed functional block diagram of the JVM 251 of FIG. 6. Referring to FIG. 7, the JVM 251 comprises a compiler 251a, an interpreter 251b, and a run-time system 251c. Typically, a program written in Java, i.e., a Java applet, is input into the compiler 251a or the interpreter 251b in the form of byte codes. Then, the input byte codes are compiled or interpreted and machine language commands obtained as results of the compiling or the interpretation are output to the run-time system 251c. The run-time system 251c executes the Java applet based upon the obtained machine language commands. A typical operation of a virtual machine, in particular, the operation of the JVM 251, is described in greater detail in “The Java Virtual Machine Specification” (Time Lindholm and Frank Yellin, ISBN 0-201-63452-X).

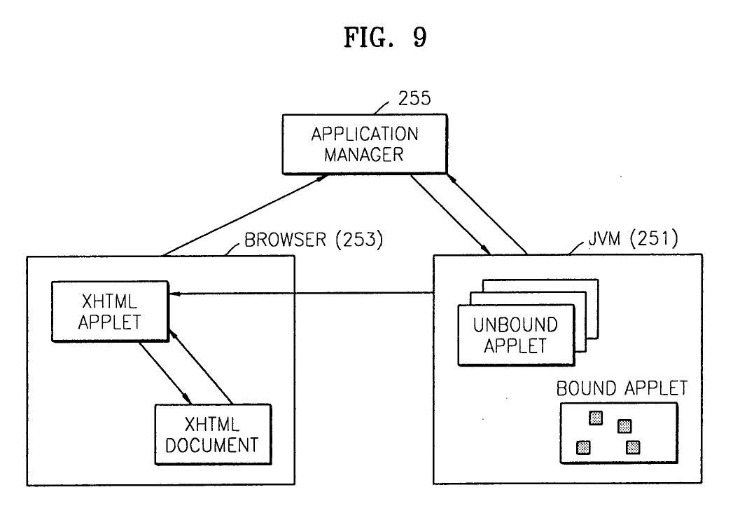

FIG. 8 is a detailed functional block diagram of the browser 253 of FIG. 6. Referring to FIG. 8, typically, the browser 253 comprises an HTML parser 253a, a CSS parser 253b, a document object model (DOM) tree generator 253c, a presentation mode determiner 253d, a script interpreter 253e, a UI controller 253f, and a layout formatter 253g. The HTML parser 253a determines whether an HTML markup document input thereinto complies with the HTML grammar. The CSS parser 253b determines whether a markup document complies with display rules specifying colors and fonts.

The DOM tree generator 253c constructs markup document data in the form of a tree by dividing a markup document into two parts, i.e., a head and a body, and further dividing the head into a title and a script tag portion. During this process, information specifying an applet to be used with the markup document and where the applet is stored are extracted. The presentation mode determiner 253d determines a display manner, such as colors and fonts.

The script interpreter 253e receives an extracted script from the DOM tree generator 253c, interprets the received script, and executes a predetermined command. The script is a sort of command program written in a script language. The UI controller 253f controls a user interface with the browser 253. The layout formatter 253g determines a layout formatter on a screen based on layout information represented by each tag of the markup document data and outputs the determined layout format to the blender 270.

The present invention provides a new applet, which can provide the same functions as a conventional applet while overcoming limits of the conventional applet. More particularly, the present invention classifies applets into bound applets and unbound applets. A bound applet indicates a conventional applet. In other words, the bound applet is defined by a predetermined tag of a markup document and is highly dependent on the markup document. In contrast to the bound applet, an unbound applet executes independent of a corresponding markup document.

More particularly, at an early stage of execution of an unbound applet, an unbound applet operates as specified in a predetermined markup document. Later, however, the unbound applet operates independent of the predetermined markup document, such that when the predetermined markup document defining the operation of the unbound applet is unloaded, the unbound applet can still be executed (i.e., continues execution) in the JVM 251. As will be described in more detail further below, a life cycle of the unbound applet is controlled by the application manager 255.

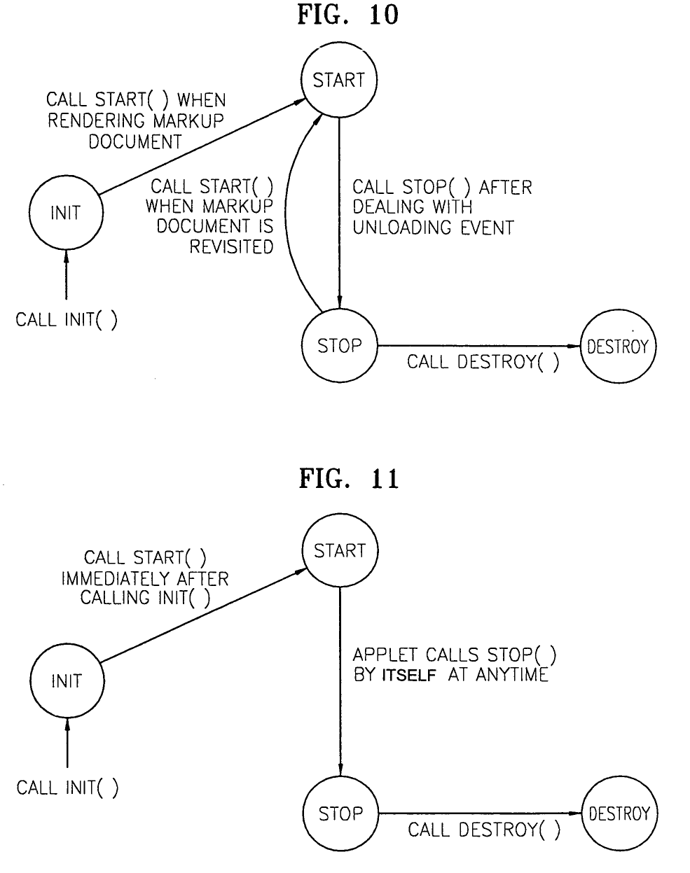

FIG. 9 is a diagram of interactions among the JVM 251, the browser 253, and the application manager 255, according to an embodiment of the present invention. An XHTML applet can be a type of an unbound applet executed by the JVM 251. However, the XHTML applet has different characteristics from other non-executing unbound applets. More specifically, the XHTML applet is directly drawn from the apparatus 200 internal memory, such as the cache memory 230, while the other unbound applets must still be retrieved from the external contents storage medium 100 or a remote external contents storage medium (not shown), such as the Internet 500, to the apparatus 200. In other words, the XHTML applet is stored in the memory of the apparatus 200 in advance according the markup document (XHTML document) and continuously executed.

The XHTML applet is executed at a stage of initializing the JVM 251. Further, typically, the XHTML applet serves as an interface for other bound or unbound applets to access a DOM tree structure of a markup document. The browser 253 informs the application manager 255 of an unbound applet event, and the JVM 251 informs the application manager 255 of an unbound applet event. The application manager 255 informed of the unbound applet event controls the life cycle of the corresponding unbound applet. Therefore, the unbound applet is executed in the JVM 251 independently of the operation of the browser 253 that displays a markup document on a screen. In a case where a command to stop the execution of the unbound applet is issued by the unbound applet, the JVM 251 informs the application manager 255 of the issuance of the command, which typically commands the JVM 251 to stop the execution of the unbound applet or to delete the unbound applet from the internal memory of the apparatus 200.

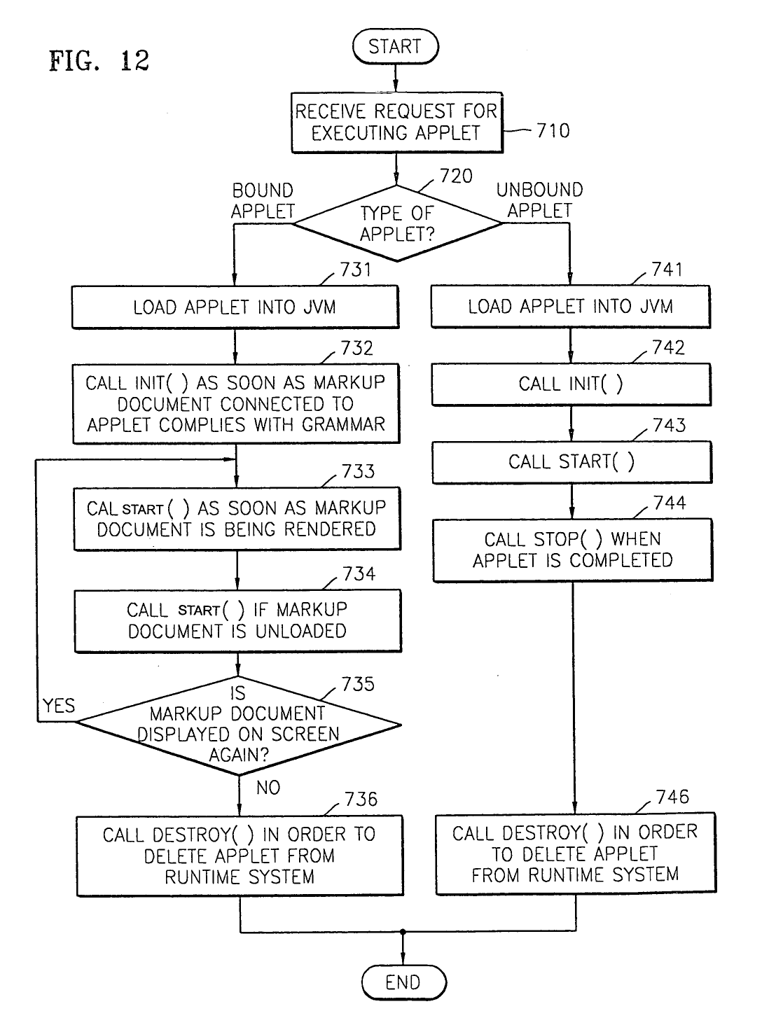

FIG. 10 is a life cycle state diagram of a bound applet. In general, a Java applet may have four or five different states. In the present invention, the life cycle of a Java applet having four different states, i.e., ‘initiate’, ‘start’, ‘stop’, and ‘destroy’, will be described. In regard to loading a bound applet, a markup document is received from the contents storage medium 100 or the Internet 500 and is stored in the cache memory 230. The markup document stored in the cache memory 230 is input into the presentation engine 250 and then parsed. Thereafter, the parsed markup document is rewritten into a DOM tree structure by the browser 253 of the presentation engine 250. The browser 253 transmits applet information written in a predetermined tag of the markup document to the application manager 255 and issues a request for executing an applet connected (bound or unbound, as the case may be) to the markup document. The application manager 255 retrieves the requested applet from the contents storage medium 100 or the Internet 500 by referring to the applet information received from the browser 253 and stores the requested applet in the cache memory 230.

Two different methods of launching a bound applet will be described as examples. However, the present invention is not limited to the described bound applet launching methods, and other bound applet launching methods can be used. One method of launching a bound applet uses an object tag of a markup document to which the applet is connected. An example of the object tag that defines a bound applet in XHTML is as follows.

<object code=“my_applet.class” codebase=“dvd://intdisc/”
archive=“my_applet.jar” codetype=“application/java”>
<param name=“first_parm” value=“one”/>
<param name=“second_parm” value=“two”/>
</object>

In the above XHTML source code, an object tag defines a bound applet “my_applet.class” in an archive “my_applet.jar.”

The other method of launching an applet uses a bound applet description file (ADF). This method is applied to a case where a bound applet is used for interpreting an image file or an animation file included in a markup document and a life cycle of the bound applet is dependent on a life cycle of the image file or the animation file. The bound applet launched by the ADF is called a plug-in applet. An example of an ADF that defines a plug-in applet is as follows.

<adf code=“flash4.class” codebase=“dvd://intdisc/”
archive=“flash4dec.jar” codetype=“application/java”
plugin=“yes”
mimetype=“application/x-shockwave-flash” version=“4.0”>
<param name=“first_parm” value=“one”/>
<param name=“second_parm” value=“two”/>
</adf>

In the above XHTML source code example, an unbound applet is defined and launched by an ADF object tag, which will be described in greater detail later. Whether an ADF is for a bound applet or an unbound applet is determined based on information “plugin=‘yes’,” which indicates that the ADF is to be used for launching a bound applet.

In regard to launching a bound applet, with reference to FIGS. 9-10 and 6-8, the application manager 255 receives the above-mentioned object tag or ADF from the browser 253 and determines whether an applet to be dealt with is a bound applet or an unbound applet. Thereafter, the application manager 255 launches the corresponding applet. As described above, in case of a bound applet, the application manager 255 interprets the object tag of a markup document, or an ADF, as the applet information, retrieves the bound applet connected to the markup document from the contents storage medium 100 or the Internet 500, and loads the bound applet in the cache memory 230.

After the bound applet is loaded, the browser 253 informs the application manager 255 that the generation of a DOM tree structure for the markup document is completed. Upon notification that the DOM tree structure for the markup document is completed, the application manager 255 issues a command to call an init( ) function to the JVM 251. If the JVM 251 calls the init( ) function from the bound applet, the bound applet falls into an ‘initiate’ state. Thereafter, the application manager 255 issues a command to call a start( ) function in the bound applet to the JVM 251 while (i.e., if) the markup document is being rendered by the browser 253. If the start( ) function is called, the bound applet falls into a ‘start’ state. Accordingly, in the order of bound applet initiation init( ) and start( ), a bound applet cannot be initiated until the DOM tree structure generation of the markup document from which the bound applet depends (i.e., the dependent upon markup document) is completed. Further, the bound applet cannot be started until start of browser rendering of the dependent upon markup document. More particularly, a bound applet is first initiated, when the browser 253 DOM generator 253c has completed generating the DOM tree structure of the dependent markup document, and then the bound applet is started upon start of browser rendering of the dependent upon markup document. In other words, the order of bound applet initiation followed by bound applet start, requires synchronization with the browser markup document rendering processes, which typically begins with completion of the DOM generation followed by layout formatter 253g outputting to the blender 270. Thereafter, if an unload event of the markup document occurs and the markup document is unloaded in the browser 253, the application manager 255 informs the JVM 251 of the markup document unload event occurrence so that the JVM 251 calls a stop( ) function from the bound applet. Accordingly, the bound applet falls into a ‘stop’ state.

If the markup document is revisited by a user and redisplayed on a screen, the application manager 255 informs the JVM 251 of the redisplay of the markup document so that the JVM 251 calls the start( ) function from the bound applet. Then, the bound applet falls again into the ‘start’ state. If the markup document is unloaded again, the bound applet falls back into the ‘stop’ state. To delete the bound applet from the run-time system 251c according to a memory management policy, the JVM 251 calls a destroy( ) function from the bound applet so that the bound applet falls into a ‘destroy’ state. Then, the bound applet can be deleted from the run-time system 251c.

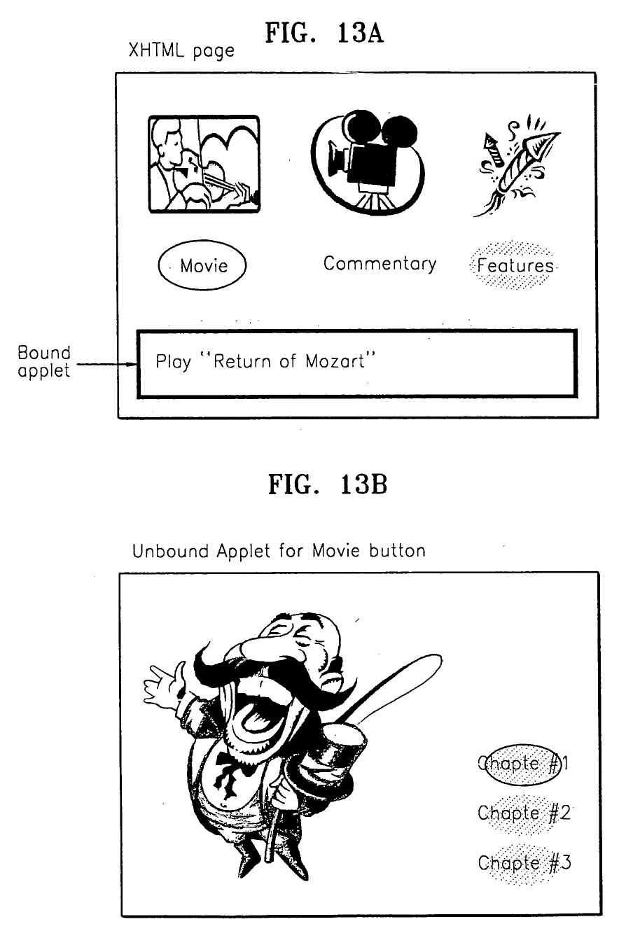

FIG. 11 is a life cycle state diagram of an unbound applet, according to an embodiment of the present invention. As shown in FIG. 11, an unbound applet, like the bound applet of FIG. 10, has four different states, such as ‘initiate’, ‘start’, ‘stop’, and ‘destroy’. As an example, a method of launching an unbound applet using an ADF will be described. However, the present invention is not limited to the described unbound launching method, and other methods of launching an unbound applet can be used.

An object tag of a markup document defines an ADF that defines an unbound applet. An example of the object tag is as follows.

<object data=“dvd://intdisc/my_applet.apm”
type=“application/apm” style=“display:none;”>
</object>

In the above object tag, “my_applet.apm” indicates an ADF that defines an unbound applet. An example of the ADF object tag is as follows.

<adf code=“my_applet.class” codebase=“dvd://intdisc/”
archive=“my_applet.jar” codetype=“application/java”>
<param name=“first_parm” value=“one”/>
<param name=“second_parm” value=“two”/>
</adf>

Because there is no plugin=‘yes’ “in the above ADF object tag, the application manager 255 can confirm that the ADF defines the unbound applet “my_applet.class.” According to what is defined in the ADF above, the application manager 255 retrieves the unbound applet “my_applet.class” from the contents storage medium 100 or the Internet 500 and loads, the unbound applet “my_applet.class” into the cache memory 230.

After loading the unbound applet “my_applet.class,” the application manager 255 issues a request for calling the init( ) function to the JVM 251, a process which does not need any browser 253 synchronization operations and is different from a process of dealing with a bound applet in which the application manager 255 is required to be in a standby state until generation of a DOM tree structure is completed by the browser 253. In contrast to the bound applet launching, for an unbound applet, the application manager 255 immediately issues a command to the JVM 251 to call the init( ) function from an unbound applet program, and the unbound applet falls into an ‘initiate’ state. As soon as the unbound applet falls into an ‘initiate’ state, the application manager 255 issues a request for calling the start( ) function to the JVM 251, after which the unbound applet falls into a ‘start’ state.

The unbound applet, unlike a bound applet, can be continuously executed in the JVM 251 irrespective of whether a markup document connected thereto is unloaded. If a command to stop the execution of the unbound applet is issued according to what is programmed in the unbound applet, the execution of the unbound applet is automatically stopped. More particularly, the JVM 251 informs the application manager 255 of the stop command issuance to stop the execution of the unbound applet. The application manager 255 issues a request for calling the stop( ) function to the JVM 251, and then the JVM 251 calls the stop( ) function from the unbound applet program. Accordingly, the unbound applet falls into a ‘stop’ state. Before deleting the unbound applet from the run-time system 251c, for example, according to a memory management policy, the JVM 251 calls the destroy( ) function from the unbound applet program so that the unbound applet falls into a ‘destroy’ state. Thereafter, the unbound applet is deleted from the run-time system 251c (i.e., unloaded from the JVM 251).

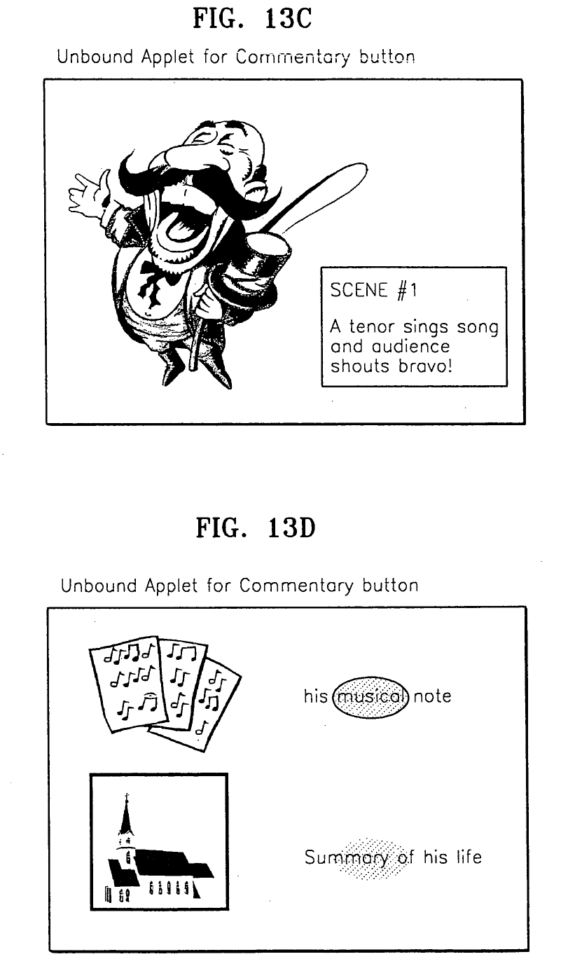

Hereinafter, a method of executing an applet, according to an embodiment of the present invention will be described in greater detail. FIG. 12 is a flowchart of executing an applet, according to an embodiment of the present invention. Referring to FIG. 12, in operation 710, the application manager 255 receives a request for executing an applet by receiving an ADF and/or applet information, written in a predetermined tag of a markup document from the browser 253.

In operation 720, the application manager 255 determines whether an applet input thereinto (i.e., a requested applet) is a bound applet or an unbound applet based on an object tag or the ADF received as the applet information from the browser 253. As a result of the applet type determination, if the applet is a bound applet, the application manager 255 retrieves the bound applet defined in the object tag of the markup document or the ADF from the contents storage medium 100 or the Internet 500, and, at operation 731, loads the requested bound applet into the cache memory 230.

At operation 732, the browser 253 informs the application manager 255 that the generation of a DOM tree structure for the markup document is completed, and the application manager 255 issues a request for calling the init( ) function to the JVM 251. When the JVM 251 calls the init( ) function from a bound applet program, at operation 732, the bound applet falls into an ‘initiate’ state. After the bound applet falls into the ‘initiate’ state, at operation 733, the application manager 255 issues a request for calling the start( ) function to the JVM 251 while the markup document is being rendered by the browser 253. Then, at operation 733, the bound applet falls into a ‘start’ state.

Thereafter, if the markup document is unloaded from the browser 253, because of an unloading event of the markup document, at operation 734, the application manager 255 issues a request for calling the stop( ) function to the JVM 251. At operation 734, the JVM 251 calls the stop( ) function from the bound applet program. Then, at operation 734, the bound applet falls into a ‘stop’ state. If determined at operation 735 that the markup document is revisited and redisplayed on a screen by a user, when the unbound applet is in the ‘stop’ state, at operation 733, the application manager 255 issues a request for calling the start( ) function to the JVM 251. After operation 735, the bound applet falls into the ‘start’ state at operation 733. On the other hand, if determined at operation 735 that the markup document has not been revisited for a certain time, at operation 736, the bound applet in the ‘stop’ state can be deleted from the run-time system 251c, for example, according to a memory management policy. At operation 736, the JVM 251 calls the destroy( ) function from the bound applet program so that the bound applet falls into a ‘destroy’ state.

If determined at operation 720 that the applet is an unbound applet, at operation 741, the application manager 255 retrieves an unbound applet defined in the ADF from the contents storage medium 100 or the Internet 500, and, at operation 741, loads the unbound applet into the cache memory 230. When, at operation 741, the unbound applet is loaded into the cache memory 230, at operation 742, the application manager 255 issues a request for calling the init( ) function to the JVM 251. Then, at operation 742, the JVM 251 calls the init( ) function from an unbound applet program. Accordingly, at operation 742, the unbound applet falls into an ‘initiate’ state. Thereafter, at operation 743, the application manager 255 issues a request for calling the start( ) function to the JVM 251, so that the JVM 251 calls the start( ) function from the unbound applet program and the unbound applet falls into a ‘start’ state.

If, at operation 744, a command to stop the execution of the unbound applet is issued (i.e., applet is completed), the JVM 251 informs the application manager 255 of the issuance of the command. Then, at operation 744, the application manager 255 issues a request for calling the stop( ) function to the JVM 251, so that the JVM 251 can call the stop( ) function from the unbound applet program. Then, at operation 744, the unbound applet falls into a ‘stop’ state. For deleting the unbound applet from the run-time system 251c, for example, according to a memory management policy, at operation 746, the JVM 251 calls the destroy( ) function from the unbound applet program, so that the unbound applet falls into a ‘destroy’ state. Thereafter, at operation 746, the unbound applet is deleted from the run-time system 251c.

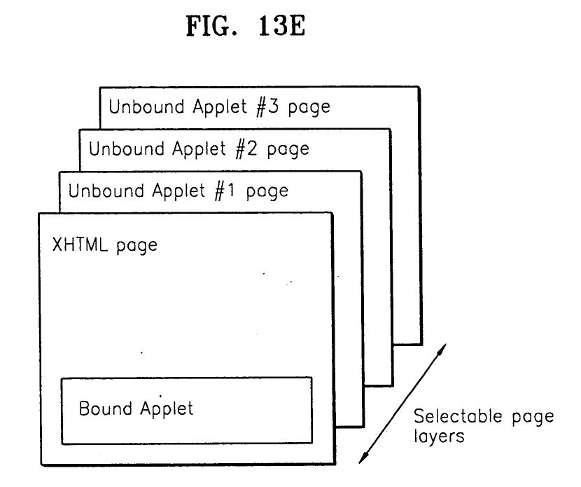

FIGS. 13A through 13E are example images of interactive contents with a bound applet and an unbound applet of the present invention. FIG. 13A is a markup document image displayed on the display device 300. In the markup document, three buttons, i.e., “Movie”, “Commentary”, and “Feature”, are provided. If a user moves an input device, such as a mouse, to get near the “Movie” button, a message ‘Play “Return of Mozart”’, which typically is embodied in the form of a bound applet, pops up at a lower part of the markup document.

Referring to FIG. 13B, when the user hits the “Movie” button of FIG. 13A, a corresponding screen realized as an unbound applet is displayed. Referring to FIG. 13C, if the user turns back to the markup document image of FIG. 13A and then hits the “Commentary” button, a corresponding screen realized as an unbound applet is displayed. Referring to FIG. 13D, if the user hits the “Feature” button on the markup document image of FIG. 13A, a corresponding screen realized as an unbound applet is displayed. The unbound applets of FIGS. 13B through 13D are executed in the JVM 251 independent of the markup document of FIG. 13A. The markup document for FIG. 13A is executed by the browser 253.

FIG. 13E illustrates simultaneous execution of the markup document of FIG. 13A and the unbound applets of FIGS. 13B through 13D. In other words, by realizing the screens of FIGS. 13B through 13D as unbound applets, once loaded in the internal memory(ies) 230 of the interactive contents reproduction apparatus 200 by the presentation manager 250 and executed (initiated and started) by the JVM 251, the unbound applets can be continuously executed in the JVM 251 independent of the markup document of FIG. 13A, and any of the unbound applets can be immediately displayed on a screen if a user selects the unbound applet, because the unbound applets are already loaded and executing in the memory by the JVM 251, and no time is consumed in retrieving and loading an unbound applet.

The present invention can be realized as computer-readable codes stored on a computer-readable recording medium. The computer-readable recording medium includes all kinds of recording devices on which data can be stored in a computer-readable manner. For example, the computer-readable recording medium includes ROM, RAM, CD-ROM, a magnetic tape, a floppy disk, an optical data storage, and a carrier wave (such as data transmission through the Internet). In addition, the computer-readable recording medium can be distributed over a plurality of computer systems connected to a network, and computer-readable codes can be stored on and executed from the computer-readable recording medium in a decentralized manner. More particularly, the above-described processes of the present invention as embodied in the functional blocks of FIGS. 5-9 and in the operations of FIGS. 10-12, of the interactive contents reproduction apparatus 200, may be implemented in computing hardware and/or software.

As described above, the apparatus and method of executing an applet according to the present invention can expand functions of an applet by classifying applets into a bound applet, which is a markup document-dependent applet, and an unbound applet, which is independent from a markup document connected thereto, and setting different life cycles for the bound applet and the unbound applet. In addition, the present invention can provide an applet that can operate irrespective of whether a markup document is loaded or unloaded by newly defining an unbound applet. More particularly, the present invention provides an apparatus and a method of executing an applet in an apparatus reproducing interactive contents by receiving a request for executing an applet from a browser, determining whether the applet is a bound applet or an unbound applet, and loading the applet. If the loaded applet is an unbound applet, predetermined commands to a virtual machine are immediately issued, so that the applet can fall into an ‘initiate’ state and into a ‘start’ state, respectively, without synchronization with the browser. In other words, for a classified unbound applet, the presentation manager 250 immediately issues commands to first initiate and then start an unbound applet, which differs from the bound applet initiation followed by the bound applet start that require waiting until completion of DOM generation and start of browser rendering of the connected (dependent) markup document.

For example, the present invention provides an interactive digital versatile disc (DVD) player, comprising a programmed computer processor controlling the player according to a process comprising processing a markup document classifying tagged applets into bound and unbound applets to display interactive contents, determining whether an applet execution of the markup document is for a bound applet or an unbound applet based upon the classifying, and if the applet is an unbound applet, launching the unbound applet by issuing predetermined commands to immediately set the unbound applet into an initiate state and into a start state, respectively. According to present invention, the launched unbound applet continuously executes independent of the markup document processing. Therefore, the present invention provides a method comprising classifying in a markup document tagged applets as bound and unbound applets, and setting different execution life cycles for the tagged applets according to the classifying, wherein the bound applet life cycle depends on the markup document life (markup document loading) and the unbound applet life cycle is independent of the life of the markup document to which the unbound applet is connected.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of executing markup document applet by a browser, comprising:
receiving a request for executing an applet from the browser;
determining whether the applet is a bound applet or an unbound applet;
loading the requested applet into a virtual machine; and
if the applet is an unbound applet, immediately issuing predetermined commands to the virtual machine to first set the unbound applet into an initiate state and then into a start state, respectively.

2. The method of claim 1, further comprising:
if the unbound applet is completed, issuing predetermined commands to the virtual machine to set the unbound applet into a stop state and into a destroy state, respectively.

3. The method of claim 1, further comprising:
if determined that the applet is a bound applet and determined by the browser that a markup document connected to the bound applet has a grammatically correct structure, issuing a predetermined command to the virtual machine to set the bound applet into an initiate state.

4. The method of claim 3, further comprising:
issuing a command to the virtual machine each time the markup document is displayed to set the bound applet into a start state while the markup document is being rendered by the browser;
if the markup document is unloaded by the browser, issuing a command to the virtual machine to set the bound applet into a stop state; and
issuing a command to the virtual machine to set the applet into a destroy state to delete the bound applet.

5. An apparatus executing a markup document applet, comprising:
a memory which stores an input markup document;
a virtual machine which executes an applet related to the markup document;
a browser which receives the markup document from the memory and outputs information on an applet related to the markup document included in the markup document; and
an application manager which receives the applet information from the browser, retrieves the applet from an external data source, controls the retrieved applet to be stored in the memory, receives a request for executing the stored applet, loads the stored applet into the virtual machine, determines whether the loaded applet is a bound applet or an unbound applet, and if the loaded applet is an unbound applet, immediately issues predetermined commands to the virtual machine to first set the loaded unbound applet into an initiate state and then into a start state, respectively.

6. The apparatus of claim 5, wherein when the virtual machine informs the application manager that the unbound applet is completed, and the application manager issues a command to the virtual machine to set the unbound applet into a stop state and issues another command to the virtual machine to set the unbound applet into a destroy state to unload the unbound applet from the virtual machine.

7. The apparatus of claim 5, wherein if the applet is a bound applet, the browser informs the application manager that the markup document connected to the bound applet has a grammatically correct structure, and the application manager issues a command to the virtual machine to set the bound applet into an initiate state.

8. The apparatus of claim 7, wherein the application manager further:
issues a command to the virtual machine to set the bound applet into a start state while the markup document is being rendered by the browser,
issues another command to the virtual machine to set the bound applet into stop state, if the markup document is unloaded by the browser,
repeatedly issues the initiate and stop commands to the virtual machine to start and stop the bound applet upon redisplaying the markup document by the browser, and
issues a command to the virtual machine to set the bound applet into a destroy state to unload the bound applet from the virtual machine.

9. A computer-readable recording medium storing at least one program controlling an interactive contents reproduction apparatus to execute a markup applet according to a process comprising:
receiving a request for executing an applet from the browser;
determining whether the requested applet is a bound applet or an unbound applet;
loading the requested applet into a virtual machine; and
if the requested applet is an unbound applet, immediately issuing predetermined commands to the virtual machine to first set the requested loaded unbound applet into an initiate state and then into a start state, respectively.

10. An interactive digital versatile disc (DVD) player, comprising:
a programmed computer processor controlling the player according to a process comprising:
processing a markup document classifying tagged applets into bound and unbound applets to display interactive contents,
determining whether an applet execution of the markup document is a bound applet or an unbound applet according to the classifying, and
if the applet is an unbound applet, launching the unbound applet by immediately issuing predetermined commands to first set the unbound applet into an initiate state and then into a start state, respectively.

11. The player of claim 10, wherein the programmed computer processor launches the unbound applet without synchronization with the markup document processing.

12. The player of claim 10, wherein the launched unbound applet continuously executes independent of the markup document processing.

13. A method, comprising:
classifying tagged applets of a markup document; and
controlling different execution life cycles of the tagged applets according to the classifying.

14. The method of claim 13, wherein the classifying comprises classifying the tagged applets into bound and unbound applets, and wherein according to the controlling, execution life cycle of a bound applet depends on the markup document life, and the execution life cycle of an unbound applet is independent of the markup document life.
